(19) United States
(12) Patent Application Publication
(10) Pub. No.: US 2014/0297469 A1
(43) Pub. Date: Oct. 2, 2014

(54) Consumer Monetization of Pre-existing Internet Usage Data

(71) Applicants: John Nicholas Dukellis, San Francisco, CA (US); David Nathaniel Levine, Washington, DC (US)

(72) Inventors: John Nicholas Dukellis, San Francisco, CA (US); David Nathaniel Levine, Washington, DC (US)

(21) Appl. No.: 13/853,510

(22) Filed: Mar. 29, 2013

(51) Int. Cl. G06Q 30/06; G06Q 50/26

(52) U.S. Cl. CPC G06Q 30/0613; G06Q 50/265
USPC 705/26.41

(57) ABSTRACT

A system is described wherein a user provides pre-existing information to a data collection company, who in turn sells the data or use of the data to third parties and offers the user a portion of the sale proceeds.

### TECHNICAL FIELD OF THE INVENTION

Embodiments of the invention relate generally to a system wherein consumers provide, to a third-party data collection company, electronic access to their pre-existing data from the Internet and other sources, and are subsequently compensated by the data collection company with a portion of the proceeds generated by the use or sale of the data.

### BACKGROUND OF THE INVENTION

For the purposes of this invention, a “Data Collection Company” is defined as a company that collects data from users or on the users' behalf and then sells the data, or the use of the data, to third parties.

Companies like Facebook, Inc. and Google, Inc. generate revenue by collecting usage data about people and then selling directed advertisements targeted to users based on the usage data. The proceeds of these sales benefit consumers through the use of free applications, such as Facebook and Gmail, as well as targeted advertising which may introduce relevant products or services to the consumer. In the wake of privacy concerns, Internet companies have moved toward providing consumer transparency with respect to the data they collect for a given user that is used for advertising purposes. These companies even allow downloads of such information.

Other data also exists on a web browser that identifies sites a user visits. To protect privacy, consumers may decide which data to upload to a website, or even use advanced privacy screens to limit data that a website may collect about a user. While a user concerned with privacy may choose to share a little as possible, other users share considerable data. Sites like Google and Facebook generate more than $100 and $12 respectively per user annually for the serving of targeted advertisements.

Interestingly, the more data a user shares, the more potential value that user has to advertisers. However, there is no mechanism today that allows users to be compensated with currency for the use or sale of the pre-existing data they have already generated. The invention answers this need in the marketplace by allowing consumers to provide their data to a third party Data Collection Company who in turn sells the data and provides a portion of the proceeds back to the consumer.

### BRIEF DESCRIPTION OF THE DRAWINGS

FIG. 1 illustrates an example embodiment covering download, upload, and sale of the data and the payment to the user.

### DETAILED DESCRIPTION

Certain details are set forth below to provide a sufficient understanding of embodiments of the invention. However, it will be clear to one skilled in the art that embodiments of the invention may be practiced without these particular details. Moreover, the particular embodiments of the present invention described herein are provided by way of example and should not be used to limit the scope of the invention to these particular embodiments. In other instances, well-known circuits, control signals, timing protocols, and software operations have not been shown in detail in order to avoid unnecessarily obscuring the invention.

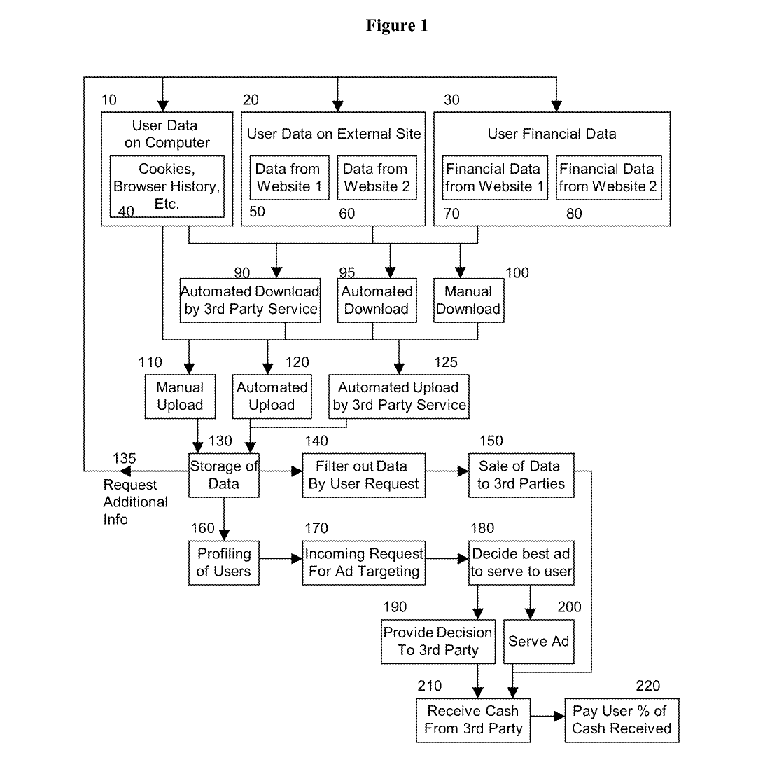

FIG. 1 provides a high level illustration of an embodiment covering the full process and flow of user data. The process can be broken down into a number of steps which shall be discussed individually, and comprises:
1. Collecting user data, and
2. Uploading user data, and
3. Sale of data to advertisers
6. Payment to user

Or, alternatively, the steps may comprise
1. Collecting user data, and
2. Uploading user data, and
4. Profiling users, and
5. Serving advertisements
6. Payment to user

1. Collecting User Data

User data is generated in number of different ways and stored in disparate places. FIG. 1 illustrates the process of data collection from various sources.

One source of data is resident on a consumers computer, including cookies created by visits to websites, data the browsing history, indicating which sites a user has visited, and other data collected by software programs on the user's computer (10). These sources are generally resident on the user's computer (40), but may be synched with online account IDs as well.

Another source of data is from websites used by the consumer (20) wherein the consumer provides data to the site though its actions such as posting comments, entering biographical data, and uploading pictures. Many of these sites now enable users to download, directly from the website, the data that these sites are storing with respect to the users. Data is often provided in a zip folder which contains a collection of documents relating to storage of personal information, such as areas of advertising focus, feeds subscribed to, contacts, login data, etc. (50).

A third source of data originates from service providers such as banks (30). These providers create statements and other downloadable information for consumers. Additionally, many banks allow access directly to the data by use of an API (from 70 directly to 90). Companies like Yodlee and Mint access banking information in order to provide additional services, such as personal financial management. In this category, many types of pre-existing data may originate from a variety of sources, not just financial information sources. For example, information may originate from a company that collects data on a user's golf scores as entered by a golf course, a health site containing health claims, or a car site containing records of property owned by the individual.

From these sources, users can manually collect data by either downloading the data or exporting the information from the application (100). Users can also automatically allow access to their data by providing usernames and passwords to a third-party provider, as is the case with Mint.com (90). A third option for collecting the data is to use a co-resident application (95), such as a browser plug-in or executable application, which then retrieves the information from the computer or guides the process to retrieve the information from an online source.

2. Uploading User Data

After a user gains access to the data, the user can manually upload the data via a standard web interface provided by the Data Collection Company (110). Alternatively, the user may have downloaded a software application (120) that packages the data and automatically uploads it to Data Collection Company, either just one time or continues to do so at the request of the user. Or, the user may have provided login names and passwords (125) to the Data Collection Company, who in turn logs into 3^{rd} party sites on behalf of the user in order to download user data. Data is then stored at the Data Collection Company (130), though some data may be discarded immediately if requested by the user or at the behest of the Data Collection Company.

After a user uploads data, the Data Collection Company may indicate to the user that additional data is required by the user (135), either to fulfill the initial requirement or to increase the money it will receive from the Data Collection Company by data sale to third parties or usage by the Data Collection Company. Over time, the user may also be contacted in order to submit fresh data such as monthly, quarterly, or annually, so that it may receive increased or additional money. The supply of this data may be automated via third party automated download (90) and automated upload (125), or may be automated by a computer resident program performing automated download (95) and automated upload (120).

3. Sale of Data to Advertisers

After aggregating user data, the Data Collection Company sells the user data (150), or a portion thereof, to third parties who use the data for market research, to serve advertisements, or for other purposes which may be indicated to the users. Users may have the option to specify which data they would be willing to share for which types of uses (140). In exchange for the sale of data, the Data Collection Company would receive from the third parties cash or other value.

4. Profiling Users

Based on the data received by the Data Collection Company, users may be categorized into a number of different buckets (160). For example, users with indicated interests in bands may be profiled as music buyers, or users with high spending as established through bank statement data may be categorized as a high earner and appropriate for particular financial service products. Users may be categorized by geography, interest, wealth, spending history, or any number of other arbitrary categories which may be useful to ultimate users of the data.

The general purpose of profiling users is to categorize users for advertisers so that appropriate advertisements may be served to the user. By categorizing users, the Data Collection Company may also receive higher values for the data sale because there are definite qualities demanded by the third parties, or because the particular qualities are worth more to the third parties (such as high spending users).

Additionally, profiling users allows the Data Collection Company to avoid distributing the actual data to any third parties. Instead, third parties indicate the type of users they would like to have advertisements served to, and then the Data Collection Company provides the advertisements directly to those users. In this scenario, the third parties never communicated directly with the user during the advertisement process.

5. Serving of Advertisements

After profiling users, the Data Collection Company may receive requests by advertisers to serve ads to users (170). The profiles allow the ads to be targeted to the ideal candidates, or possibly only to be served to candidates with particular qualities (180). The Data Collection Company would then serve the ads appropriate for given users (200).

Another alternative is that advertisers or other third parties may request, in real-time or non-real-time, whether a particular user is part of the data set owned by the Data Collection Company. If the user is part of the data set, the Data Collection Company may then be asked to choose from among several advertisements based on particular qualities (180), and to provide the response back to the third party so that the third party may serve the ads with the benefit of the information (190).

In exchange for the sale of profiles, ad decisions, or ad serving, the Data Collection Company would receive from the third parties cash or other value.

6. Payment to User

After receiving cash (210) from third parties for the sale of data, the sale of decisions based on the data, or the serving of advertisements, the Data Collection Company then provides a portion of the proceeds back to the users who provided the data (220). Users may receive either a percentage of the proceeds, a minimum value, or a maximum value. Users may also receive more compensation based on the amount of information provided, whether as a higher percent or as the same percent of a larger value. The user may be required to enter payment details in order to receive the payment, such as the provision of a bank account number indicated that the person lives within a particular geography. The user may also be required to enter tax identification information in the event it may be required by legislation.

The invention claimed is:

1. A computer implemented method for implementing a mechanism comprising the steps of:
a consumer authorizing the use of his or her pre-existing usage and/or descriptive data generated by the consumer's use of software applications, where online or offline and stored by use of the software applications;
the uploading of the consumer data to a third-party website;
the sale or rental of consumer data by the third-party website provider to a separate entity wherein cash or other monetary value is received by the third-party website; and
the distribution from the third-party website provider to the consumer of a portion of the proceeds of the sale or rental of consumer's data to the separate entity;

2. The method of claim 1 further comprising the initial step of:
the download by the consumer of consumer's data from an existing website to the consumer's computer in preparation for the uploading of the consumer data to a third-party website.

3. The method of claim 2 further comprising the initial step of:
the export by the consumer of consumer's data from an existing software application resident on the consumer's computer in preparation for the uploading of the consumer data to a third-party website.

4. The method of claim 1 further comprising the initial step of:
the automated download, through use of a software application running on the consumer's computer, of consumer's data from an existing website to the consumer's computer in preparation for the uploading of the consumer data to a third-party website,
wherein part or all of the download process is automated by use of the software application.

5. The method of claim 2 wherein:
the consumer provides to the third-party website a username and password for accessing a separate website on behalf of the consumer for the purpose of downloading the consumer's data either (i) from the separate website to the consumer's computer for uploading to the third-party website, or (ii) directly from the separate website to the third-party website.

6. The method of claim 1 wherein:
the monetary value received by the consumer from the third-party website is in the form of a gift certificate to one or more specified retailers.

7. The method of claim 1 wherein:
the monetary value received by the consumer from the third-party website is between a minimum and maximum value, as specified by the third-party website prior to the consumer's uploading of information.

8. The method of claim 1 wherein:
the payment to the consumer occurs directly from the separate website to the consumer.

9. The method of claim 1 further comprising the additional step of:
the upload of further data generated by the consumer by use of separate software applications, whether online or offline, to the third-party website,
wherein the further data provides additional information about the consumer which may increase the value of the information for sale to separate entities, and
wherein the further data occurs as a result of the consumer's use of software applications unrelated to the provider of the third-party website.

10. The method of claim 9 further comprising the additional step of:
the consumer is prompted to manually provide additional data, separate from the pre-existing data generated by use of software applications, directly to the third-party website,
wherein the additional data provides additional information about the consumer which may increase the value of the information for sale to separate entities.

11. The method of claim 1 wherein:
the consumer is prompted to provide permissions about which areas of the consumer's data may and may not be sold to separate entities.

12. A computer implemented method for implementing a mechanism comprising the steps of:
a consumer authorizing the use of his or her pre-existing usage and/or descriptive data generated by the consumer's use of software applications, where online or offline and stored by use of the software applications;
the uploading of the consumer data to a third-party website;
the serving of ads to a consumer while the consumer uses software applications wherein the consumer's data is analyzed to serve appropriate advertisements and wherein a cash or other monetary value is received by the third-party website from sponsoring advertisers for the ads served to the consumer or for the ads clicked by the consumer; and
the distribution from the third-party website provider to the consumer of a portion of the proceeds generated from sponsoring advertisers.

13. The method of claim 12 further comprising the initial step of:
the automated download, through use of a software application running on the consumer's computer, of consumer's data from an existing website to the consumer's computer in preparation for the uploading of the consumer data to a third-party website,
wherein part or all of the download process is automated by use of the software application.

14. The method of claim 3 wherein:
the monetary value received by the consumer from the third-party website is between a minimum and maximum value, as specified by the third-party website prior to the consumer's uploading of information.
